(19) United States
(12) Patent Application Publication
(10) Pub. No.: US 2014/0036558 A1
(43) Pub. Date: Feb. 6, 2014

(54) Power Controllers, Power Supplies and Control Methods Therefor

(71) Applicant: Leadtrend Technology Corporation, Hsinchu (TW)

(72) Inventors: Ming Chang Tsou, Hsinchu (TW); Meng Jen Tsai, Hsinchu (TW); Chao Chih Lin, Hsinchu (TW); Ren Yi Chen, Hsinchu (TW)

(21) Appl. No.: 13/944,055

(22) Filed: Jul. 17, 2013

Related U.S. Application Data
(60) Provisional application No. 61/677,478, filed on Jul. 31, 2012.

(51) Int. Cl. H02M 3/02; H02M 7/02

(52) U.S. Cl. CPC H02M 3/02; H02M 7/02
USPC 363/74; 323/234

(57) ABSTRACT

Disclosure includes an exemplified power controller for controlling a power switch in a power supply. The power supply converts an input power source into an output power source. The exemplified power controller comprises a maximum frequency maker, a voltage detector, and a logic circuit. Based on dependence of a maximum switching frequency upon a compensation signal, the maximum frequency maker provides a control signal with a minimum switching cycle. The compensation signal correlates to an output power from the output power source, and the minimum switching cycle is the reciprocal of the maximum switching frequency. The voltage detector detects a line voltage of the input power source. The logic circuit controls the power switch in response to the control signal, and makes a switching cycle of the power switch not less than the minimum switching cycle. The line voltage determines the dependence.

### CROSS-REFERENCE TO RELATED APPLICATION

This application claims priority to and the benefit of U.S. Provisional Application No. 61/677,478 filed on Jul. 31, 2012, which is incorporated by reference in its entirety.

### BACKGROUND

The present disclosure relates generally to switched mode power supplies, and more particularly, to the switched mode power supplies whose switching frequency changes in response to a line voltage of an input power source.

A power supply is generally required for every electric appliance, to convert an input power source from batteries or AC power grids into an output power source with specific ratings. As technology advances, it becomes a routine for power supplies to operate more efficiently or have higher conversion efficiency. As known in the art, the conversion efficiency of a power supply is the ratio of the output power from the output power source to the input power from the input power source.

FIG. 1 shows a table demonstrating conversion efficiency requirements for power supplies with different power ratings. The first row of the table shows power ratings, the second row the conversion efficiency requirements of 2013 published by Department of Energy (DoE), and the third row the conversion efficiency requirements of level V in an international efficiency marking protocol. Each column in the fourth row is the difference between the corresponding columns in the second and third rows. It can be concluded from the fourth row of the table that DoE demands much more conversion efficiency improvement, especially for the power supplies with power ratings ranging from 3 W to 10 W.

In order to comply with the tighter power efficiency requirements, one of the mostly preferred power supplies is switched mode power supply. FIG. 2 demonstrates a switched mode power supply 10 in the art, known as a flyback converter. A bridge rectifier 12 has an input port connected to alternative-current (AC) power grids, and accordingly provides, from its output port, a rectified direct-current input power source V_{LINE} and a ground line. A transformer 14 includes 3 windings: primary winding PRM, secondary winding SEC and auxiliary winding AUX. A power controller 16 switches a power switch 18 to energize or de-energize the transformer 14. A turned-on power switch 18, performing a short circuit, causes the input power source V_{LINE} energizing the transformer 14. In the opposite, a turned-off power switch 18, performing an open circuit, makes the transformer 14 de-energize to build up an output power source V_{OUT} and an operation voltage source V_{CC}. The power controller 16 in FIG. 2 utilizes primary side control (PSR) , meaning the voltage of the output power source V_{OUT} is indirectly regulated and detected via the help from the feedback node FB and the auxiliary winding AUX. A compensation signal V_{COMP} is generated based on the detection result at the feedback node FB, so as to modulate the duty cycle of the power switch 18 and to regulate the output power source V_{OUT}. A duty cycle represents the ratio of the time period when the power switch 18 is turned on to the whole switching cycle of the power switch 18. Generally speaking, the compensation signal V_{COMP} correlates to the output power from the output power source V_{OUT}, and the higher compensation signal V_{COMP}, the more duty cycle, and the higher output power from the output power source V_{OUT}.

When the load 15 supplied by the output power source V_{OUT} is light, the power controller 16 decreases the switching frequency of the power switch 18, thereby reducing the average switching loss in view of time, and increasing the overall power conversion efficiency. FIG. 3 shows a frequency vs. voltage plot, exemplifying the dependency of the switching frequency f_{SW} upon the compensation signal V_{COMP}. Generally speaking, the higher output power form the output power source V_{OUT}, the higher compensation signal V_{COMP}, and the higher switching frequency f_{SW}.

The dependency of the switching frequency f_{SW} upon the compensation signal V_{COMP} shown in FIG. 3 alone cannot seemingly make a power supply comply with the 2013 conversion efficiency requirements of DoE. Accordingly, it is a desire in the art to have further advanced approach to have higher conversion efficiency.

### SUMMARY

Embodiments of the present invention disclose a power controller for controlling a power switch in a power supply, which converts an input power source into an output power source. The power controller comprises a maximum frequency maker, a voltage detector, and a logic circuit. Based on dependence of a maximum switching frequency upon a compensation signal, the maximum frequency maker provides a control signal with a minimum switching cycle. The compensation signal correlates to an output power from the output power source, and the minimum switching cycle is the reciprocal of the maximum switching frequency. The voltage detector detects a line voltage of the input power source. The logic circuit controls the power switch in response to the control signal, and makes a switching cycle of the power switch not less than the minimum switching cycle. The line voltage determines the dependence.

Embodiments of the present invention further disclose a method suitable for a power supply including a power switch. The power supply converts an input power source into an output power source. A line voltage of the input power source is detected. A compensation signal correlating to the output power source is provided. A minimum switching cycle is determined based on the line voltage and the compensation. The power switch is switched to determine a switching cycle, which is not less than the minimum switching cycle.

### BRIEF DESCRIPTION OF THE DRAWINGS

The invention can be more fully understood by the subsequent detailed description and examples with references made to the accompanying drawings, wherein:

FIG. 1 shows a table demonstrating conversion efficiency requirements for power supplies with different power ratings;

FIG. 2 demonstrates a switched mode power supply in the art;

FIG. 3 shows a frequency vs. voltage plot, exemplifying the dependency of the switching frequency f_{SW} upon the compensation signal V_{COMP};

FIG. 4 shows a power controller 30 according to embodiments of the invention;

FIG. 5 exemplifies a line voltage detector;

FIG. 6 demonstrates waveforms of some signals in FIG. 4;

FIG. 7 shows 3 kinds of dependence of the maximum switching frequency f_{SW-MAX} upon the compensation signal V_{COMP};

FIG. 8 further shows 3 kinds of dependence of the maximum switching frequency f_{SW-MAX} upon the compensation signal V_{COMP}; and

FIG. 9 further shows 3 kinds of dependence of the maximum switching frequency f_{SW-MAX} upon the compensation signal V_{COMP}.

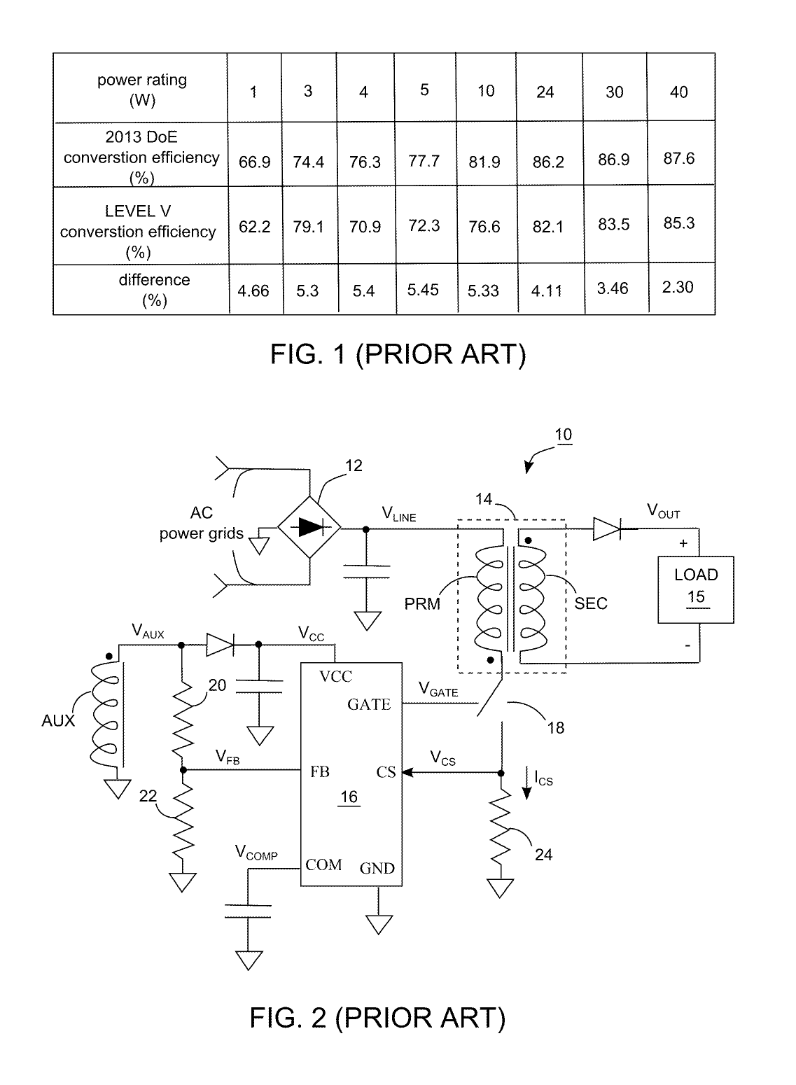

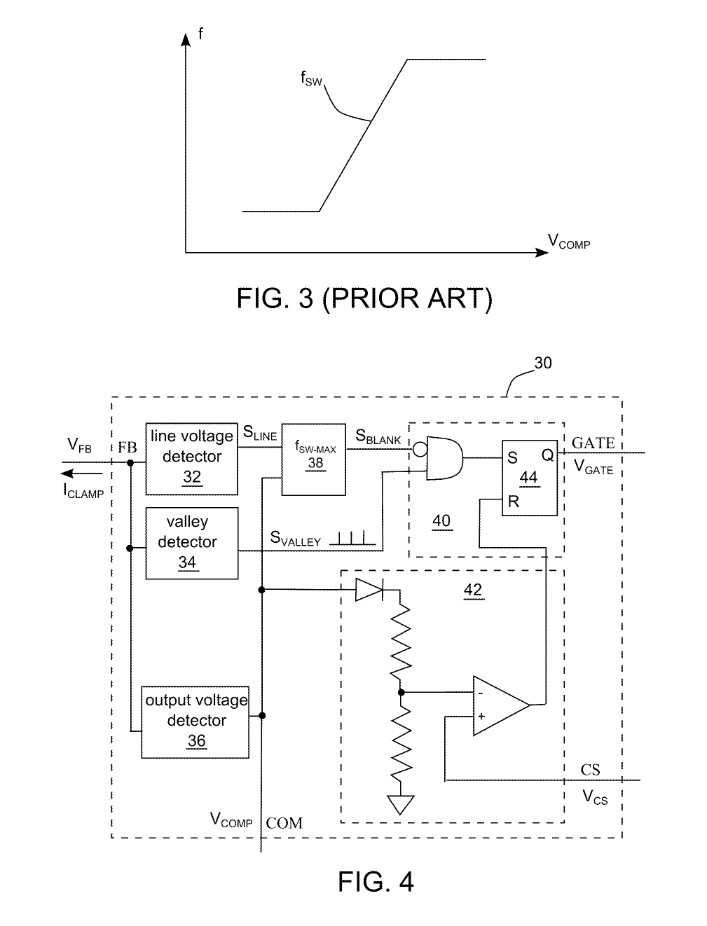

### DETAILED DESCRIPTION

Devices or apparatuses with the same symbol in this specification are, but not limited to, those with the same or similar functionality, structure or feature, and alternatives thereto, even though not detailed herein for brevity, could be understood and embodied by the persons skilled in the art based upon the teachings described in this specification.

FIG. 4 shows a power controller 30 according to embodiments of the invention. Exemplified in an embodiment, the power controller 30 in FIG. 4 replaces the power controller 16 in FIG. 2, to control the power switch 18 for converting the input power source V_{LINE} into the output power source V_{OUT} with required ratings. As shown in FIG. 2, resistors 20 and 22, forming a voltage divider, are connected between the auxiliary winding AUX and the ground line, and the joint node FB between the resistors 20 and 22 provides a feedback signal V_{FB}. Connected between the power switch 18 and the ground line is a current-sense resistor 24, which senses the current I_{CS} flowing through the power switch 18 and the primary winding PRM to provide current-sense signal V_{CS} at the node CS. In other words, current-sense signal V_{CS}, in a way, represents a current in the power switch 18.

The power controller 30 periodically turns on and off the power switch 18. Hereinafter, a switch is “ON” when it performs a short circuit conducting current, and is “OFF” when it performs an open circuit. ON time T_{ON} means the duration in a switching cycle when the power switch 18 is ON, and in the opposite OFF time T_{OFF} means that in a switching cycle when the power switch 18 is OFF. A switching cycle T_{SW} therefore consists of one ON time T_{ON} and one OFF time T_{OFF}, and a reciprocal of a switching cycle T_{SW} is denoted as a switching frequency f_{SW}.

Inside the power controller 30 shown in FIG. 4 are, but not limited to, a line voltage detector 32, a valley detector 34, an output voltage detector 36, a maximum frequency maker 38, a logic 40 and a peak control circuit 42. The line voltage detector 32, the valley detector 34, and the output voltage detector 36, all connected to the feedback node FB, detects or confines the feedback voltage V_{FB} during different periods of time, to achieve desired functions.

Based on the compensation signal V_{COMP}, the peak control circuit 42 substantially defines a peak voltage V_{CS-PEAK} of the current-sense signal V_{CS}. When the power switch 18 is ON, transformer 14 energizes, such that the current I_{CS} flowing through the power switch 18 and the current-sense signal V_{CS} as well increases over time. The current-sense voltage V_{CS} reflects the magnitude of the current I_{CS}. Once the current-sense signal V_{CS} exceeds a limitation corresponding to the compensation signal V_{COM}, the peak control circuit 42 resets a SR flip flop 44 in the logic 40, which accordingly turns the power switch 18 OFF and ends one ON time T_{ON}. As the power switch 18 is OFF, the current-sense signal V_{CS} increases no more and drops to zero, such that the peak voltage V_{CS-PEAK} is decided. In a way, the peak control circuit 42, in association with the compensation signal V_{COMP} decides both the peak voltage V_{CS-PEAK} and the length of an ON time T_{ON}.

When the transformer 14 is de-energizing, the voltage drop V_{AUX} over the auxiliary winding AUX is a reflective voltage substantially reflecting the voltage of the output power source V_{OUT}. Therefore, the output voltage detector 36, via the help from the auxiliary winding AUX, and the resistors 20 and 22, is capable of sensing indirectly the voltage of the output power source V_{OUT}. The output voltage detector 36 could use the difference between the voltage of the output power source V_{OUT} and a predetermined target voltage to control the compensation signal V_{COMP}.

After the transformer 14 completes the de-energizing, the voltage drop V_{AUX} starts oscillating with attenuate amplitude, due to a parasitic LC tank in association with the primary winding PRM and the power switch 18. The valley detector 34 intends to provide valley signal S_{VALLEY}, which indicates the timing when the voltage drop V_{AUX} is about at a local minimum, or a voltage valley. As an example, the valley detector 34 could sense the moment when the voltage drop V_{AUX} drops across 0 volt, and after a predetermined time delay generates a short pulse at the valley signal S_{VALLEY}, which, if not blanked by logic gates, sets the SR flip flop 44 in the logic 40 to end the OFF time T_{OFF}. A well-predetermined time delay could make the short pulse occurring about at the moment of the occurrence of a voltage valley, which might be the 1^{st} voltage valley, the 2^{nd} voltage valley, or any of subsequent ones after the completion of the de-energizing. This kind of technology is referred to as “valley switching” in the art. Valley switching turns ON the power switch 18 at the moment when the voltage drop across the power switch 18 is very low or about 0V to enjoy low switching loss. Switched mode power supplies utilizing the valley switching are called quadrature-resonance (QR) power converters, which if the switching occurs at about the 1^{st} voltage valley the switching loss of a power switch is the least, and the later the switching the higher the switching loss.

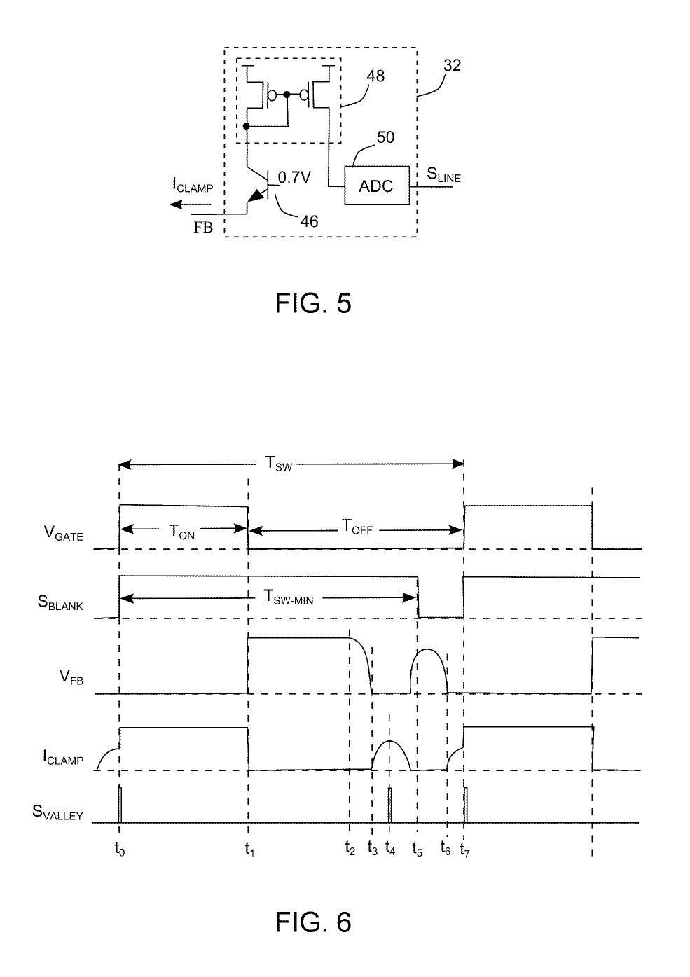

During an ON time T_{ON}, the power switch 18 is ON and the voltage drop V_{AUX} over the auxiliary winding AUX has a negative value reflecting the line voltage of the input power source V_{LINE}. By clamping the feedback voltage V_{FB} at about 0 volt, the line voltage detector 32 can detect or sample the line voltage of the input power source V_{LINE} to generate a control signal S_{LINE}. FIG. 5 exemplifies the line voltage detector 32, which has a BJT 46, a current mirror 48, and an analog-to-digital converter (ADC) 50. When the voltage drop V_{AUX} is negative, BJT 46 provides clamping current I _{CLAMP} to keep feedback signal V_{FB} about 0 volt. The ADC 50 provides digital control signal S_{LINE}, which represents a mirror current generated from the current mirror 48 by mirroring the clamping current I_{CLAMP}. During an ON time T_{ON}, the clamping current I_{CLAMP} is about in proportion to the line voltage of the input power source V_{LINE}, which is represented therefore by the digital control signal S_{LINE}. In other embodiments, the ADC 50 might be omitted and the analog mirror current is used as the control signal S_{LINE}.

The maximum frequency maker 38 in FIG. 4 receives the control signal S_{LINE} and the compensation signal V_{COMP} so as to generate a blanking signal S_{BLANK}, which provides a minimum switching cycle T_{SW-MIN}, the reciprocal of which is a maximum switching frequency f_{SW-MAX}. The maximum frequency maker 38 provides the information needed to make the switching frequency f_{SW} no more than the maximum switching frequency f_{SW-MAX}. Dependence of the maximum switching frequency f_{SW-MAX} upon the compensation signal V_{COMP} is set inside the maximum frequency maker 38, and this dependence could be decided or changed by the control signal S_{LINE}. For example, if the control signal S_{LINE} indicates the line voltage of the input power source V_{IN} has been about 115v for several consecutive switching cycles, the control signal S_{LINE} could cause the maximum frequency maker 38 to have first dependence corresponding to the 115V line voltage. Otherwise, if the line voltage is switched to 230V and continues for several switching cycles, the maximum frequency maker 38 could have second dependence corresponding to the 230V line voltage. The minimum switching cycle T_{SW-MIN} starts as an ON time T_{ON} begins. Before the minimum switching cycle T_{SW-MIN} depletes, the blanking signal S_{BLANK} blanks any short pulse at the valley signal S_{VALLEY} to avoid it from setting SR flip flop 44. For example, in case that the short pulse expected to correspond to the 1^{st} voltage valley shows before the minimum switching cycle T_{SW-MIN} depletes, the OFF time T_{OFF} does not end at the moment around the occurrence of the 1^{st} voltage valley. In case that the short pulse expected to correspond to the 2^{nd} voltage valley shows after the minimum switching cycle T_{SW-MIN} depletes, the OFF time T_{OFF} ends at the moment around the occurrence of the 2^{nd} voltage valley, to start a next ON time T_{ON}.

FIG. 6 demonstrates waveforms of some signals in FIG. 4, which include, from top to bottom, gate-driving signal V_{GATE} at the gate node GATE, the blanking signal S_{BLANK} the feedback signal V_{FB}, the clamping current I_{CLAMP} out of the feedback node FB, and the valley signal S_{VALLEY}. Please refer to not only FIG. 6 but also FIGS. 2 and 4 for following paragraphs.

A switching cycle T_{SW} and an ON time T_{ON} begin at time t₀ when the gate-driving signal V_{GATE} and the blanking signal S_{BLANK} change to “1” in logic. In the meantime, the voltage drop V_{AUX} becomes a negative value in proportion to the line voltage of the input power source V_{LINE}. The clamping current I_{CLAMP} is positive to make the feedback signal V_{FB} clamped to be about 0V, and the magnitude of the clamping current I _{CLAMP} is about in proportion to the line voltage.

During the ON time T_{ON}, the line voltage detector 32 provides the control signal S_{LINE} based upon the clamping current I_{CLAP} The control signal S_{LINE} and the compensation signal V_{COMP} together determine the minimum switching cycle T_{SW-MIN}, the duration when the blanking signal S_{BLANK} is “1” in logic. In one embodiment, the control signal S_{LINE} generated during an ON time T_{ON} immediately affects the minimum switching cycle T_{SW-MIN} of the very switching cycle. In another embodiment, only if the control signal S_{LINE} has been stable for several switching cycles does the minimum switching cycle T_{SW-MIN} change accordingly. For example, a lowpass filter could process the control signal S_{LINE} before it affects the minimum switching cycle T_{SW-MIN}.

At time t₁, the gate-driving signal V_{GATE} turns to “0” in logic to call the end of an ON time T_{ON} and the beginning of an OFF time T_{OFF}. For example, an OFF time T_{OFF} begins because the current-sense signal V_{CS} exceeds a limitation corresponding to the compensation signal V_{COMP}. The transformer 14 starts de-energizing at time t₁, and the voltage drop V_{AUX} turns to have a positive value, which is in association with the output voltage of the output power source V_{OUT}. The feedback signal V_{FB} meanwhile is positive as being generated by dividing the voltage drop V_{AUX} and the clamping current, whose purpose is to prevent the feedback signal V_{FB} from being negative, becomes about zero accordingly.

At time t₂, the transformer 14 completes its de-energizing, the feedback signal V_{FB} starts falling as the voltage drop V_{AUX} starts oscillating.

At time t₃, the valley detector 34 finds that the feedback signal drops below 0V or the clamping current I_{CLAMP} turns to be positive. At time t₄, a predetermined delay after t₃, the valley detector 34 sends a short pulse at the valley signal S_{VALLEY}, to indicate substantially the moment when the 1^{st} voltage valley of the voltage drop V_{AUX} occurs. Nevertheless, the blanking signal S_{BLANK} is still “1” in logic, such that the short pulse at the valley signal S_{VALLEY} cannot reach SR flip flop 44, whose output remains “0” in logic as a result.

At time t₅, the minimum switching cycle T_{SW-MIN} ends and blanking signal S_{BLANK} becomes “0” in logic, blanking no more the short pulse at the valley signal S_{VALLEY}.

At time t₆, the valley detector 34 once again finds that the feedback signal drops below OV or the clamping current I_{CLAMP} turns to be positive. Thus, the valley detector 34, at time t₇, sends another short pulse at the valley signal S_{VALLEY} to indicate substantially the moment when the 2^{nd} voltage valley occurs. This short pulse, free from being blanked, sets the SR flip flop 44, whose output now turns to “1” in logic. Accordingly, at time t₇, an OFF time ends, and an ON time of a next switching cycle T_{SW} begins.

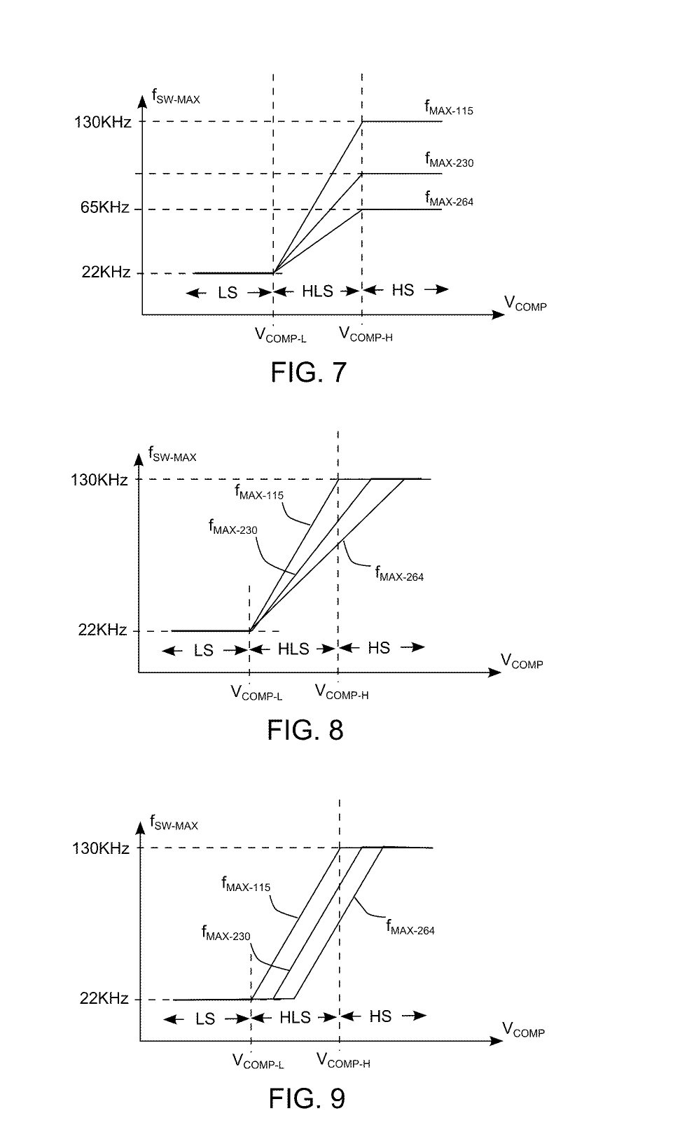

FIG. 7 shows 3 kinds of dependence of the maximum switching frequency f_{SW-MAX} upon the compensation signal V_{COMP}, preset by the maximum frequency maker 38, and respectively represented by curves f_{MAX-115}, f_{MAX-230}, and f_{MAX-264}. In one embodiment, when the control signal S_{LINE} indicates the line voltage being 115V, the dependence of the maximum switching frequency f_{SW-MAX} upon the compensation signal V_{COMP} is demonstrated by the curve f_{MAX-115}. Similarly, when the line voltage is 230V/264V, the dependence is demonstrated by the curve f_{MAX-230}/f_{MAX-264}. It can be concluded from FIG. 7 that the control signal S_{LINE} determines the dependence of the maximum switching frequency f_{SW-MAX} upon the compensation signal V_{COMP}.

Taking the curve f_{MAX-115} as an example, it includes 3 segments substantially located in 3 different power ranges in view of the value of the compensation signal V_{COMP} involved. These 3 power ranges, as shown in FIG. 7, are high power range HS, transition power range HLS, and low power range LS, respectively, separated by about compensation values V_{COMP-H} and V_{COMP-L}. Inside the high power range HS when the compensation signal V_{COMP} exceeds the compensation value V_{COMP-H}, the maximum switching frequency f_{SW-MAX} is about a constant, exemplified as being 130 KHz in FIG. 7. Inside the low power range LS when the compensation signal V_{COMP} is below the compensation value V_{COMP-L} the maximum switching frequency f_{SW-MAX} is about another constant, exemplified as being 22 KHz in FIG. 7. Inside the transition power range HLS when the compensation signal V_{com}p is between the compensation values V_{COMP-H} and V_{COMP-L} the maximum switching frequency f_{SW-MAX} has a positive, linear relationship with the compensation signal C_{COMP} as the curve f_{MAX-115} inside the transition power range HLS is a straight line with a positive slope. The curve f_{MAX-115} benefits a switched mode power supply in several aspects. When the compensation signal V_{COMP} is low, meaning that the load 15 is light or moderate, the power controller 30 with the curve f_{MAX-115} could cause the power switch 18 to switch at the 2^{nd} or any subsequent voltage valley, enjoying low average switch loss from valley switching and low switching frequency. When the compensation signal V_{COMP} is high, meaning that the load 15 is heavy, the power controller 30 with the dependence of the curve f_{MAX-115} could turn on the power switch 18 at about the moment when the 1^{st} voltage valley occurs, possibly beneficial in the lowest switching loss.

The explanations of the curves f_{MAX-230} and f_{MAX-264} are omitted herein for brevity, because both are similar with that of the curve f_{MAX-115} and easy to derive based on the aforementioned teaching.

Shown of FIG. 7, curves f_{MAX-115}, f_{MAX-230} and f_{MAX-264} for defining the maximum switching frequency f_{SW-MAX} inside the high power range HS are 3 different constants, respectively. The constant of curve f_{MAX-115} in the high power range HS is about 130 KHz and that of curve f_{MAX-264} in the high power range HS about 65 KHz. In other words, the line voltage of the input power source V_{LINE} determines the constant value of the maximum switching frequency f_{SW-MAX} inside the high power range HS. The constant value in the high power range HZ in FIG. 7 becomes less when the line voltage of the input power source V_{LINE} increases.

In FIG. 7, the compensation values V_{COMP-H} and V_{COMP-L} are independent to the line voltage of the input power source V_{IN} because the curves f_{MAX-115}, f_{MAX-230}, and f_{MAX-264} have the same high power range HS, transition power range HLS, and low power range LS.

For a conventional QR converter switching at the 1^{st} voltage valley, if operated to power a constant load, its switching frequency f_{SW} will increase following the increment of the line voltage due to a shorter ON time T_{ON}. The higher switching frequency f_{SW}, the more average power consumed to charge and discharge a control node of a power switch in view of time. In other words, a conventional QR converter might suffer from a less power conversion efficiency when the line voltage increases.

The power controller 30 employs the dependence of the maximum switching frequency f_{SW-MAX} upon the compensation signal V_{COMP} shown in FIG. 7 to improve power conversion efficiency, especially when the line voltage of the input power source V_{LINE} increases. It is a trend shown in FIG. 7 that the maximum switching frequency f_{SW-MAX} decreases when the line voltage increases. The trend implies that the switching frequency f_{SW} of a power supply using the power controller 30, even though it tends to increase for a higher line voltage, is not necessarily higher for a higher line voltage, but might become lower because of a lower maximum switching frequency f_{SW-MAX}. For example, a power supply with the power controller 30 could turn on a power switch at the occurrence of the 1^{st} voltage valley when the line voltage is about 115V. Nevertheless, if the line voltage changes to 264V, turning on the power switch might differently happen at the occurrence moment of a 2^{nd} voltage valley or a subsequent voltage valley, simply because the maximum switching frequency f_{SW-MAX} for the line voltage of 264V prevents the 1^{st} voltage valley switching. A lower switching frequency f_{SW} could consume less power, in view of time, to charge and discharge a control node of a power switch, and might render a better power conversion efficiency.

FIG. 8 shows, in another embodiment of the invention, 3 kinds of dependence of the maximum switching frequency f_{SW-MAX} upon the compensation signal V_{COMP}, preset by the maximum frequency maker 38. Similar with those in FIG. 7, curves f_{MAX-115}, f_{MAX-230} and f_{MAX-264} in FIG. 8 represent the 3 kinds of dependence when the line voltages are 115V, 230V and 264V, respectively. Shown in FIG. 8, the compensation value V_{COMP-L} which separates a low power range LS from a transition power range, is substantially the same for all the curves f_{MAX-115}, f_{MAX-230} and f_{MAX-264}, and the transition power range HLS of the curve f_{MAX-264} is the widest in comparison with the other two. The slope of the curve f_{MAX-264} inside the transition power range HLS is the least-tilted in comparison with the other two. In other words, the line voltage of the input power source V_{LINE} affects both the width of a transition power range and the slope of the curve in the transition power range.

FIG. 9 shows, in another embodiment of the invention, 3 kinds of dependence of the maximum switching frequency f_{SW-MAX} upon the compensation signal V_{COMP}, preset by the maximum frequency maker 38. Similar with those in FIGS. 7 and 8, curves f_{MAX-115}, f_{MAX-230}, and f_{MAX-264} in FIG. 9 represent the 3 kinds of dependence when the line voltages are 115V, 230V and 264V, respectively. Shown in FIG. 9, the transition power ranges HLS for the curves f_{MAX-115}, f_{MAX-230}, and f_{MAX-264} have almost the same width. Furthermore, as the curves f_{MAX-115}, f_{MAX-230}, and f_{MAX-264} in FIG. 9 have titled straight lines substantially parallel to each other, the slopes of these curves in their transition power ranges HLS are about the same, too. The transition power ranges HLS corresponding to the curves f_{MAX-115}, f_{MAX-230} and f_{MAX-264} are different in having different boundaries (the compensation values V_{COMP-H} and V_{COMP-L}). The compensation value V_{COM-L} for the curve f_{MAX-264}, which defines the left boundary of a transition power range HLS, is the smallest in comparison with the other two for the curves f_{MAX-115} and f_{MAX-230} respectively. FIG. 9 shows an example that the compensation values V_{COM-L} and V_{COM-H} might change in response to the line voltage of the input power source V_{LINE}.

The aforementioned embodiments use the auxiliary winding AUX to detect indirectly the line voltage of the input power source V_{LINE}, but this invention is not limited to, however. In another embodiment, a power controller is an integrated circuit with a line voltage detector connected to the input power source V_{LINE} via a high-voltage startup pin and a startup resistor, and is capable of directly detecting the line voltage of the input power source V_{LINE} without the help from any inductive device.

Embodiments of the invention might be suitable for power supplies with low power ratings, and could be possible candidates for the power supplies to comply with the 2013 conversion efficiency requirements of DoE.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power controller for controlling a power switch in a power supply, wherein the power supply converts an input power source into an output power source, the power controller comprising:
a maximum frequency maker, for, based on dependence of a maximum switching frequency upon a compensation signal, providing a control signal with a minimum switching cycle, wherein the compensation signal correlates to an output power from the output power source, and the minimum switching cycle is the reciprocal of the maximum switching frequency;
a voltage detector, for detecting a line voltage of the input power source; and
a logic circuit, coupled to the voltage detector and the maximum frequency maker, for controlling the power switch in response to the control signal, and making a switching cycle of the power switch not less than the minimum switching cycle;
wherein the line voltage determines the dependence.

2. The power controller as claimed in claim 1, further comprising:
a valley detector for detecting a feedback signal to determine the switching cycle via the logic circuit;
wherein the valley detector is capable of causing the power switch to perform valley switching.

3. The power controller as claimed in claim 1, further comprising:
a peak control circuit, for determining a peak current in the power switch based on the compensation signal.

4. The power controller as claimed in claim 1, further comprising:
an output voltage detector, for detecting the output voltage of the output power source and controlling the compensation signal in response to difference between the output voltage and a target voltage.

5. The power controller as claimed in claim 1, wherein
the dependence of the maximum switching frequency upon the compensation signal is capable of being expressed by segments in a high power range, a transition power range and a low power range in view of the value of the compensation signal;
inside the high power range, the maximum switching frequency is about a first constant;
inside the low power range, the maximum switching frequency is about a second constant less than the first constant; and
inside the transition power range, the maximum switching frequency has a positive relationship with the compensation signal.

6. The power controller as claimed in claim 5, wherein the line voltage of the input power source determines the first constant.

7. The power controller as claimed in claim 5, wherein inside the transition power range the maximum switching frequency has a linear relationship with the compensation signal, and a slope of the linear relationship correlates to the line voltage.

8. The power controller as claimed in claim 7, wherein the transition power range is about between a high compensation value and a low compensation value, and the low compensation value is independent to the line voltage.

9. The power controller as claimed in claim 7, wherein the transition power range is about between a high compensation value and a low compensation value, and the low compensation value varies in response to the change of the line voltage.

10. The power controller as claimed in claim 1, wherein the voltage detector, via an inductive device, detects the line voltage.

11. A power supply, capable of converting an input power source into an output power source, comprising:
an inductive device;
a power switch for controlling a current passing through the inductive device; and
the power controller as claimed in claim. 1, for controlling the power switch;
wherein the inductive device has a primary winding and an auxiliary winding, and the primary winding is connected between the input power source and the power switch.

12. The power supply as claimed in claim 11, further comprising:
a valley detector for detecting a feedback signal to control the power supply via the logic circuit, so as to determine the switching cycle;
wherein the valley detector is capable of causing the power switch to perform valley switching; and
the valley detector is coupled to the auxiliary winding.

13. The power supply as claimed in claim 11, further comprising:
a startup resistor, connected between the input power source and the voltage detector.

14. The power supply as claimed in claim 11, wherein the valley detector detects the line voltage via the auxiliary winding.

15. A control method suitable for a power supply including a power switch, wherein the power supply converts an input power source into an output power source, the control method comprising:
detecting a line voltage of the input power source;
providing a compensation signal correlating to the output power source;
determining a minimum switching cycle based on the line voltage and the compensation;
switching the power switch to determine a switching cycle; and
making the switching cycle not less than the minimum switching cycle.

16. The control method as claimed in claim 15, wherein
the minimum switching cycle is the reciprocal of a maximum switching frequency having dependence upon the compensation signal;
the dependence is capable of being expressed by segments in a high power range, a transition power range and a low power range in view of the value of the compensation signal;
inside the high power range, the maximum switching frequency is about a first constant;
inside the low power range, the maximum switching frequency is about a second constant less than the first constant; and
inside the transition power range, the maximum switching frequency has a positive relationship with the compensation signal.

17. The control method as claimed in claim 16, further comprising:
changing the first constant in response to the change of the line voltage.

18. The control method as claimed in claim 16, wherein inside the transition power range the maximum switching frequency has a linear relationship with the compensation signal, and the method further comprises a step of changing a slope of the linear relationship based on the line voltage.

19. The control method as claimed in claim 16, wherein the transition power range is about between a high compensation value and a low compensation value, and the method further comprises a step of changing the low compensation value in response to the change of the line voltage.

20. The control method as claimed in claim 15, comprising:
providing the compensation signal based on a feedback signal correlating to a drop voltage of an inductive device; and
turning on the power switch when the drop voltage is about at a voltage valley.
